(19) United States
(12) Patent Application Publication
(10) Pub. No.: US 2018/0128701 A1
(43) Pub. Date: May 10, 2018

(54) STRAIN GAGE CALIBRATION SYSTEM

(71) Applicant: Sikorsky Aircraft Corporation, Stratford, CT (US)

(72) Inventors: Hyungdae Lee, Pittsford, NY (US); Carl Palmer, Pittsford, NY (US); Joshua Tyler Koelle, Spencerport, NY (US); Jeremy Sheldon, Henrietta, NY (US)

(21) Appl. No.: 15/571,547

(22) PCT Filed: Mar. 3, 2016
(86) PCT No.: PCT/US2016/020639

§ 371 Date: Nov. 3, 2017

Related U.S. Application Data
(60) Provisional application No. 62/158,030, filed on May 7, 2015.

(51) Int. Cl. G01L 25/00

(52) U.S. Cl. CPC G01L 25/00

(57) ABSTRACT

A system for strain gage calibration includes a data acquisition system operable to receive sensor inputs from a force sensor as a force input and a strain gage as a strain output. The strain gage detects a strain measurement of a structure under test in response to an excitation force applied by an excitation device, and the force sensor detects the excitation force. The system also includes a data processing system operable to perform calibration feature extraction of a plurality of calibration features from time and frequency domain responses of the force input and the strain output, and to determine a calibration factor of the strain gage based on a correlation of the calibration features to reference calibration features. The force input and the strain output are preprocessed before the calibration feature extraction to filter noise, remove outlying data, and temporally align the force input and the strain output.

### STATEMENT REGARDING FEDERALLY SPONSORED RESEARCH OR DEVELOPMENT

This invention was made with Government support with the United States Navy under Contract No. N68335-08-C-0237 and N68335-10-C-0230. The Government therefore has certain rights in this invention.

### BACKGROUND

The subject matter disclosed herein generally relates to sensor calibration, and more particularly to a strain gage calibration system using responses to dynamic inputs.

Strain gages are utilized on in-service aircraft to track the load history of various parts and structures of the aircraft. The data are used to determine how much ‘life’ is being used from cyclic and peak loads in the parts and structures. Fatigue life predictions depend on the accuracy of strain gage readings. The usefulness of strain data for calculating structure usage can be compromised by difficulties in consistently manufacturing and installing the strain gages from one aircraft to the next. Variations of up to 10% gage readings may be observed for the same external load due to these variations. A small calibration error can lead to large errors in life expended predictions. Effective calibration improves accuracy of fatigue life predictions.

Current methods for in-situ calibration of strain gages include applying static stresses to an aircraft in a full-scale test rig or performing in-flight calibration by flying the aircraft through prescribed maneuvers that apply ‘known’ loads. However, these methods have not been entirely successful due to cost and time requirements.

### BRIEF SUMMARY

According to one embodiment, a system for strain gage calibration includes a data acquisition system operable to receive a plurality of sensor inputs from a force sensor as a force input and a strain gage as a strain output. The strain gage is operable to detect a strain measurement of a structure under test in response to an excitation force applied by an excitation device, and the force sensor is operable to detect the excitation force. The system also includes a data processing system operable to perform calibration feature extraction of a plurality of calibration features from time and frequency domain responses of the force input and the strain output, and to further determine a calibration factor of the strain gage based on a correlation of the calibration features to reference calibration features. The force input and the strain output are preprocessed before the calibration feature extraction to filter noise, remove outlying data, and temporally align the force input and the strain output.

In addition to one or more of the features described above or below, or as an alternative, further embodiments could include where wavelet-based de-noising is applied to filter noise using a non-linear application of a plurality of noise reduction thresholds.

In addition to one or more of the features described above or below, or as an alternative, further embodiments could include where outlying data are removed by applying density-based outlier detection to identify and remove one or more data values outside of a cluster defined by a search neighborhood comprising a plurality of data values.

In addition to one or more of the features described above or below, or as an alternative, further embodiments could include where a cross-correlation is computed between the force input and the strain output after noise filtering to determine a time delay between the force input and the strain output.

In addition to one or more of the features described above or below, or as an alternative, further embodiments could include where the force input and the strain output are temporally aligned by aligning a peak of the force input with a peak of the strain output after adjusting for the time delay.

In addition to one or more of the features described above or below, or as an alternative, further embodiments could include where a final calibration factor is computed based on a linear regression of the calibration features to the reference calibration features for strain values over a plurality of impact events using a constant setting for the excitation force.

In addition to one or more of the features described above or below, or as an alternative, further embodiments could include where the constant setting for the excitation force is determined based on repeated calibration factor determination over a range of values for the excitation force, and identification of a setting of the excitation force resulting in a smallest deviation in the calibration factor across multiple tests.

In addition to one or more of the features described above or below, or as an alternative, further embodiments could include where the excitation device is a handheld impact hammer including the force sensor, and the data processing system is a handheld computer system.

According to another embodiment, a method of strain gage calibration includes receiving a plurality of sensor inputs from a force sensor as a force input and a strain gage as a strain output. The strain gage is operable to detect a strain measurement of a structure under test in response to an excitation force applied by an excitation device, and the force sensor is operable to detect the excitation force. The force input and the strain output are preprocessed to filter noise, remove outlying data, and temporally align the force input and the strain output. Calibration feature extraction of a plurality of calibration features from time and frequency domain responses of the force input and the strain output is performed after the preprocessing. A calibration factor of the strain gage is determined based on a correlation of the calibration features to reference calibration features.

### BRIEF DESCRIPTION OF THE SEVERAL VIEWS OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 schematically depicts a block diagram of a system in accordance with embodiments;

FIG. 2 schematically depicts a block diagram of a processing system in accordance with embodiments;

FIG. 3 depicts an excitation device positioned at a target on a structure under test in accordance with embodiments;

FIG. 4 depicts a process flow of an analysis procedure for strain gage calibration in accordance with embodiments; and

FIG. 5 depicts a process flow for data preprocessing to improve accuracy of strain gage calibration in accordance with embodiments.

### DETAILED DESCRIPTION

Exemplary embodiments are directed to strain gage calibration that utilizes a portable system (e.g., a hand-held unit) producing low level and localized dynamic loads near individual strain gages to obtain in-situ structural response information. The strain gage calibration system measures the load from a force sensor and response from a strain gage to provide a calibration factor for each strain gage relative to matching gages on a reference structure, such as a reference aircraft. Embodiments can provide strain calibration of fleet aircraft with full-scale test accuracy but without the cost and complexity of imparting full aircraft loads or a sequence of in-flight maneuvers.

In one embodiment, calibration starts with exciting a fleet aircraft structure using an impact or periodic force. Next, the force input and structural response are measured using a force sensor and a strain gage respectively. The measured signals are checked to flag hardware degradation or poor excitation/data. The data are preprocessed to eliminate or reduce noise and outliers. Time-based alignment of the force and strain data is also performed, as data from the force sensor and strain gage are separately collected absent direct synchronization. Calibration features are extracted from the results of spectral analysis (i.e., frequency response function and coherence) of force and strain signals and correlated with the features determined from a reference aircraft structure using the same measurement process to obtain calibration factors at substantially optimal frequency bands having high coherence values. The calibration factors are combined to obtain a final calibration factor of the strain gage. Although described in terms of an aircraft, embodiments are applicable to numerous types of structures that include strain gages, such as any type of aircraft, watercraft, or land-based vehicle.

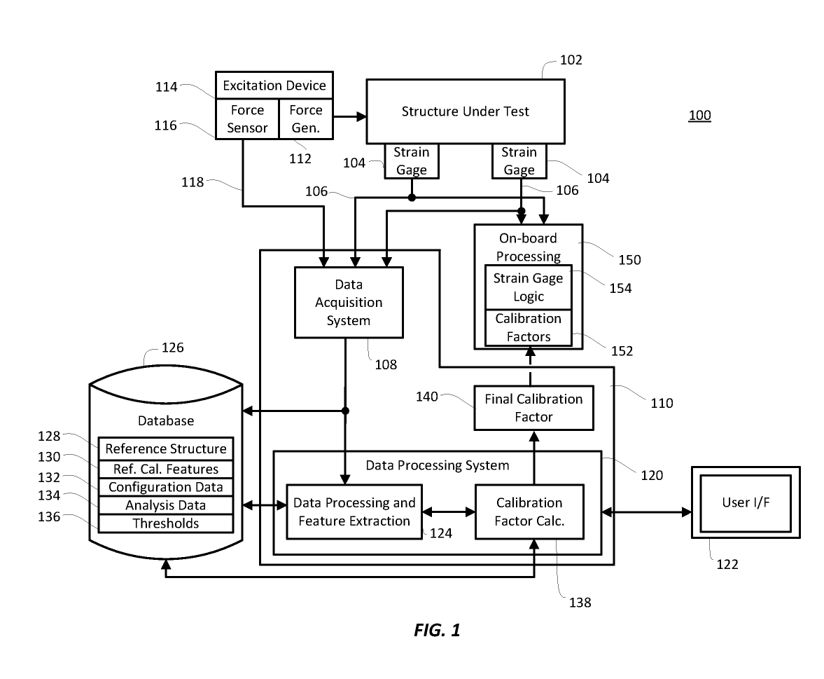

Turning now to FIG. 1, a system 100 is depicted in accordance with embodiments. A structure under test 102 includes a plurality of strain gages 104. The strain gages 104 provide sensor inputs as strain output 106 to a data acquisition system 108 of a strain gage calibration system 110. Strain gages 104 are operable to detect a strain measurement of the structure under test 102 in response to an excitation force applied by a force generator 112 of an excitation device 114. The excitation device 114 can apply a periodic force and/or an impact force to the structure under test 102. The excitation device 114 includes a force sensor 116 operable to detect the excitation force and provide a force input 118 as one of the sensor inputs to the data acquisition system 108. The data acquisition system 108 can include, for example, analog-to-digital converters (not depicted) and processing logic (not depicted) to validate and preprocess the force input 118 and strain output 106. For example, the data acquisition system 108 can filter noise, remove outlying data, and temporally align the force input 118 and the strain output 106 prior to calibration feature extraction by data processing system 120 of the strain gage calibration system 110. Alternatively, a portion or all of the preprocessing of the force input 118 and strain output 106 can be performed by the data processing system 120. The data acquisition system 108 and data processing system 120 can be physically separate components or combined in a common chassis. For instance, the data processing system 120 can be a handheld computer system, such as a tablet computer, mobile device, or laptop computer. Alternatively, the data processing system 120 can be incorporated in a mobile test cart where the data acquisition system 108 is embodied in one or more computer interface cards of the mobile test cart. A user interface 122 of the strain gage calibration system 110 can include one or more displays, such as a touchscreen, and/or other input devices, e.g., buttons, a keyboard, and the like.

In an embodiment, the data processing system 120 includes data processing and feature extraction 124 that interfaces with a database 126 for comparisons against reference structure data 128. The reference structure data 128 defines calibration parameters for a reference structure upon which comparisons are made against the structure under test 102. In one embodiment, the strain gage calibration system 110 populates the reference structure data 128 and reference calibration features 130 by defining parameters and monitoring a test response of a structure identified as a reference. The database 126 can also store configuration data 132, analysis data 134, and thresholds 136 among other data values. The configuration data 132 can define parameters of calibration, such as desired loads and target frequencies. The analysis data 134 can capture a history of results and intermediate data files for further processing. The thresholds 136 can define analysis limits. The database 126 can be embodied in non-volatile storage and may be accessible by other systems (not depicted).

The data processing system 120 can also include calibration factor calculation logic 138 that can access the database 126 for reference data and perform comparisons relative to calibration features identified by the data processing and feature extraction 124. The data processing and feature extraction 124 of the data processing system 120 is operable to perform calibration feature extraction of a plurality of calibration features from time and frequency domain responses of the force input 118 and the strain output 106. The calibration factor calculation logic 138 of the data processing system 120 can determine a calibration factor of a strain gage 104 based on a correlation of the calibration features to reference calibration features 130. Calibration factors can be computed multiple times at a same target location to improve accuracy and be summarized as a final calibration factor 140 for a particular strain gage 104 at a target location. The final calibration factor 140 for each strain gage 104 is provided to on-board processing 150 as calibration factors 152 for use by strain gage logic 154 under normal operational conditions, e.g., during operation of an aircraft that includes the structure under test 102.

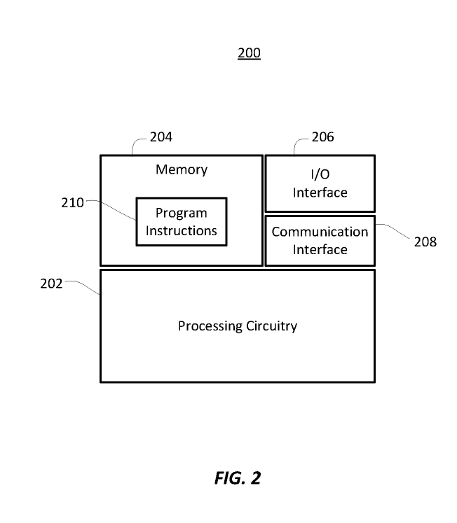

FIG. 2 schematically depicts a block diagram of a processing system 200 in accordance with embodiments. One or more instances of the processing system 200 can be embodied in the data acquisition system 108 of FIG. 1, in the data processing system 120 of FIG. 1, and/or in the on-board processing 150 of FIG. 1. The processing system 200 includes processing circuitry 202, memory 204, an input/output (I/O) interface 206, and a communication interface 208. The processing circuitry 202 can be any type or combination of computer processors, such as a microprocessor, microcontroller, digital signal processor, application specific integrated circuit, programmable logic device, and/or field programmable gate array, and is generally referred to as a central processing unit (CPU). The memory 204 can include volatile and non-volatile memory, such as random access memory (RAM), read only memory (ROM), or other electronic, optical, magnetic, or any other computer readable storage medium onto which data and control logic as described herein are stored. Therefore, the memory 204 is a tangible storage medium where program instructions 210 executable by the processing circuitry 202 are embodied in a non-transitory form. The program instructions 210 can include, for example, instructions to implement portions of the data acquisition system 108 of FIG. 1, the data processing and feature extraction 124 of FIG. 1, the calibration factor calculation logic 138 of FIG. 1, and/or the strain gage logic 154 of FIG. 1.

The I/O interface 206 can include a variety of input interfaces, output interfaces, and support circuitry. For example, in various embodiments the I/O interface 206 can acquire data from the strain gages 104 of FIG. 1 and/or force sensor 116 of FIG. 1, access the database 126 of FIG. 1, and/or interface with the user interface 122 of FIG. 1. The communication interface 208 may be included to support wired, wireless, and/or fiber optic network or point-to-point communication.

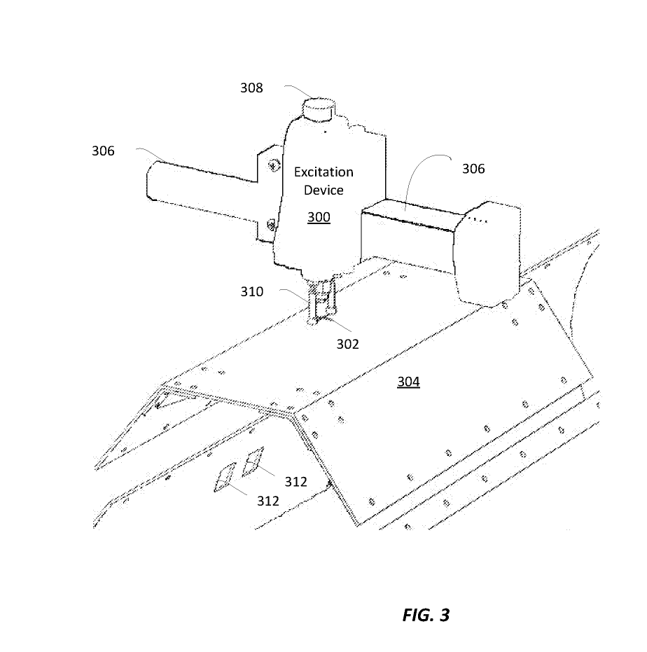

FIG. 3 depicts an excitation device 300 positioned at a target 302 on a structure under test 304 in accordance with embodiments. The excitation device 300 is an example of the excitation device 114 of FIG. 1 depicted as a handheld impact hammer comprising a pair of handles 306, a dial 308 to set an excitation force, and standoffs 310 to assist in positioning the excitation device 300 with respect to the target 302. The target 302 can be selected relative to strain gage locations 312 such that impact force is readily detectable as a strain response in the structure under test 304.

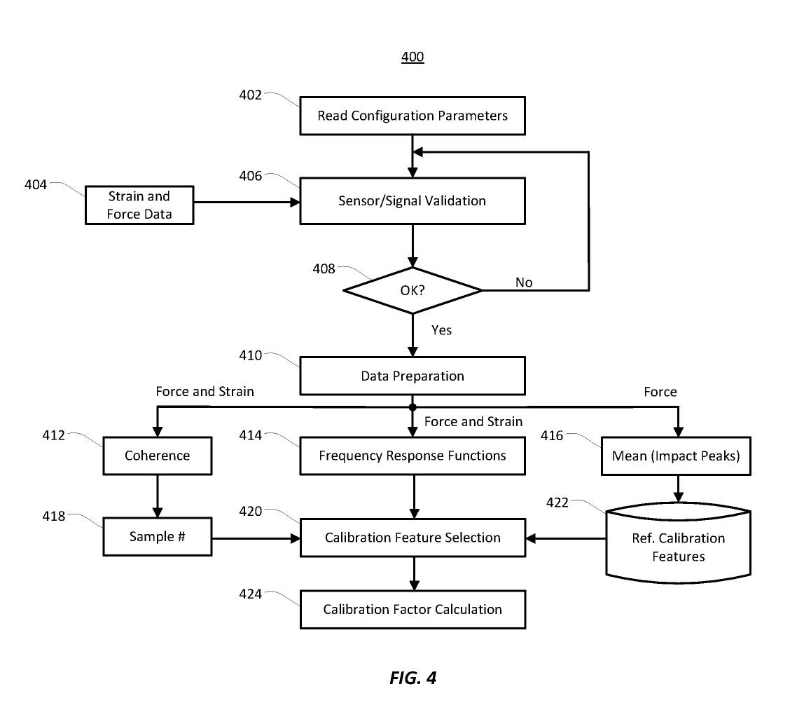

FIG. 4 depicts a process flow 400 of an analysis procedure for strain gage calibration that can be performed by the strain gage calibration system 110 of FIG. 1 in accordance with embodiments. At block 402, configuration parameters are read from configuration data 132 of FIG. 1. The configuration parameters can include a number of impact events, a coherence threshold, a frequency band, sensor validation parameters, and the like for sensor validation and calibration feature extraction. Strain and force data 404 are provided from the force input 118 and strain output 106 of FIG. 1 to perform sensor and signal validation at block 406. The sensor and signal validation may track specific signal characteristics and statistically-based features of high bandwidth data to identify basic sensor failures such as clipping, weak signal, over-amplification, bias, noise, as well as other forms of corrupt high frequency data. Once it is determined that the validation passes at block 408, data preparation 410 is performed. Data preparation 410 can include DC removal, noise reduction, abnormal peaks removal, impact event centering, and windowing. After data preparation 410, coherence 412, frequency response functions (FRFs) 414 between the force and strain, and a mean load 416 of impact events are calculated. A number of samples 418 are selected that exceed a coherence threshold, and calibration feature selection 420 selects the FRFs 414 corresponding to the selected samples 418 and calculated mean load from reference and target strain gages 422 (e.g., from reference calibration features 130 of FIG. 1). Reference FRFs are selected based on the mean load 416.

At block 424, a calibration factor is calculated from a ratio of reference and target FRFs at the same or substantially similar loading conditions. The final calibration factor 140 of FIG. 1 can be computed based on a linear regression of the calibration features to the reference calibration features for strain values over a plurality of impact events using a constant setting for the excitation force. The constant setting for the excitation force can be determined based on repeated calibration factor determination over a range of values for the excitation force, and a setting of the excitation force can be identified that results in a smallest deviation in the calibration factor across multiple tests.

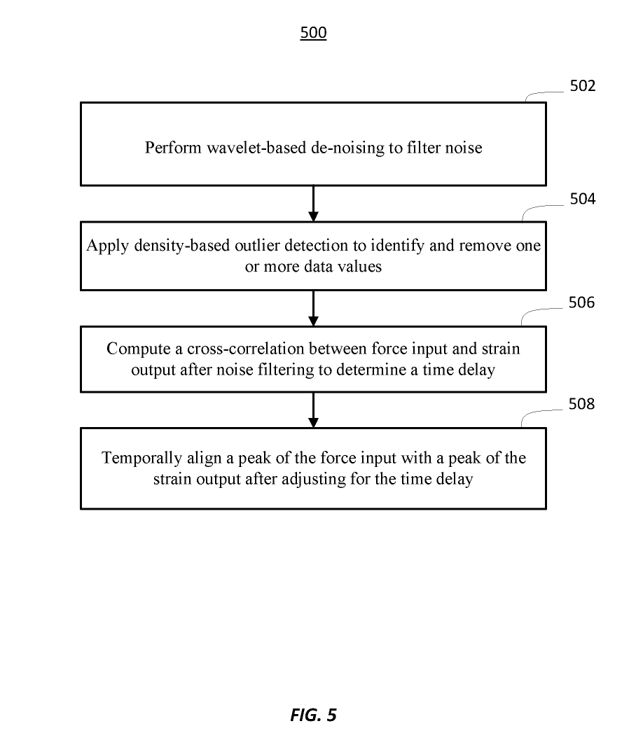

FIG. 5 depicts a process flow of a method 500 for increasing accuracy of strain gage calibration in accordance with embodiments. The method 500 may be performed by the strain gage calibration system 110 of FIG. 1 as part of data preparation 410 of FIG. 4. Accordingly, the method 500 is described in reference to FIGS. 1-5. Although depicted in a particular order, it will be understood that the blocks of method 500 can be reordered, combined, or further partitioned.

At block 502, wavelet-based de-noising is applied to filter noise using a non-linear application of a plurality of noise reduction thresholds. Wavelet based de-noising can estimate a signal that is corrupted by additive noise using a wavelet approach. Each signal can be decomposed into ‘N’ wavelets. Wavelets are reduced or eliminated that are less than noise reduction thresholds. An inverse wavelet transform can be applied using thresholded wavelet coefficients to obtain a de-noised signal (i.e., the original signal estimate).

At block 504, outlying data are removed by applying density-based outlier detection to identify and remove one or more data values outside of a cluster defined by a search neighborhood comprising a plurality of data values. Outliers are those points that are considered not density reachable from other points within a dataset and do not meet the criteria of the minimum number of points within a neighborhood (e.g., a radius of search circle). A density-based outlier detection method regards clusters as dense regions of objects in the data space that are separated by regions of low density. Searching through the dataset can be performed to return clusters and outliers found within the dataset. Clusters are places in the dataset where the points are very close together, and outliers are those points in the dataset where the points are very spread apart, as defined according to one or more thresholds.

At block 506, a cross-correlation is computed between the force input 118 and the strain output 106 after noise filtering to determine a time delay between the force input 118 and the strain output 106. Cross-correlation is a function of the relative time between the signals, sometimes called a sliding dot product. The cross-correlation is similar in nature to the convolution of two functions. Whereas convolution involves reversing a signal, then shifting it and multiplying by another signal, correlation only involves shifting it and multiplying (no reversing).

At block 508, the force input 118 and the strain output 106 are temporally aligned by aligning a peak of the force input 118 with a peak of the strain output 106 after adjusting for the time delay. The alignment accounts for differences in synchronization, signal processing, and transport delays. Since the force input 118 and the strain output 106 may each include multiple peaks, time shifting is initially performed to account for the time delay and then peak alignment is performed to ensure that the signals are properly aligned. This avoids erroneous alignment to an abnormal peak, such as an internal spring bounce or secondary impact. Additional signal conditioning can also be performed.

Technical effects include increasing strain gage calibration accuracy using a portable calibration system to detect an excitation and compute calibration factors to be applied by a separate strain gage monitoring system associated with a structure under test. Increased calibration accuracy results in more accurate readings for strain gages installed in fixed locations on a structure, such as an aircraft.

The terminology used herein is for the purpose of describing particular embodiments only and is not intended to be limiting. While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. A system for strain gage calibration, comprising:
a data acquisition system operable to receive a plurality of sensor inputs from a force sensor as a force input and a strain gage as a strain output, the strain gage operable to detect a strain measurement of a structure under test in response to an excitation force applied by an excitation device, and the force sensor operable to detect the excitation force; and
a data processing system operable to perform calibration feature extraction of a plurality of calibration features from time and frequency domain responses of the force input and the strain output, and to further determine a calibration factor of the strain gage based on a correlation of the calibration features to reference calibration features, wherein the force input and the strain output are preprocessed before the calibration feature extraction to filter noise, remove outlying data, and temporally align the force input and the strain output.

2. The system according to claim 1, wherein wavelet-based de-noising is applied to filter noise using a non-linear application of a plurality of noise reduction thresholds.

3. The system according to claim 1, wherein outlying data are removed by applying density-based outlier detection to identify and remove one or more data values outside of a cluster defined by a search neighborhood comprising a plurality of data values.

4. The system according to claim 1, wherein a cross-correlation is computed between the force input and the strain output after noise filtering to determine a time delay between the force input and the strain output.

5. The system according to claim 4, wherein the force input and the strain output are temporally aligned by aligning a peak of the force input with a peak of the strain output after adjusting for the time delay.

6. The system according to claim 1, wherein a final calibration factor is computed based on a linear regression of the calibration features to the reference calibration features for strain values over a plurality of impact events using a constant setting for the excitation force.

7. The system according to claim 6, wherein the constant setting for the excitation force is determined based on repeated calibration factor determination over a range of values for the excitation force, and identification of a setting of the excitation force resulting in a smallest deviation in the calibration factor across multiple tests.

8. The system according to claim 1, wherein the excitation device is a handheld impact hammer comprising the force sensor, and the data processing system is a handheld computer system.

9. A method of strain gage calibration, comprising:
receiving a plurality of sensor inputs from a force sensor as a force input and a strain gage as a strain output, the strain gage operable to detect a strain measurement of a structure under test in response to an excitation force applied by an excitation device, and the force sensor operable to detect the excitation force;
preprocessing the force input and the strain output to filter noise, remove outlying data, and temporally align the force input and the strain output;
performing calibration feature extraction of a plurality of calibration features from time and frequency domain responses of the force input and the strain output after the preprocessing; and
determining a calibration factor of the strain gage based on a correlation of the calibration features to reference calibration features.

10. The method according to claim 9, further comprising performing wavelet-based de-noising to filter noise using a non-linear application of a plurality of noise reduction thresholds.

11. The method according to claim 9, wherein outlying data are removed by applying density-based outlier detection to identify and remove one or more data values outside of a cluster defined by a search neighborhood comprising a plurality of data values.

12. The method according to claim 9, further comprising computing a cross-correlation between the force input and the strain output after noise filtering to determine a time delay between the force input and the strain output.

13. The method according to claim 12, wherein the force input and the strain output are temporally aligned by aligning a peak of the force input with a peak of the strain output after adjusting for the time delay.

14. The method according to claim 9, wherein a final calibration factor is computed based on a linear regression of the calibration features to the reference calibration features for strain values over a plurality of impact events using a constant setting for the excitation force.

15. The method according to claim 9, wherein the constant setting for the excitation force is determined based on repeated calibration factor determination over a range of values for the excitation force, and identification of a setting of the excitation force resulting in a smallest deviation in the calibration factor across multiple tests.
